(19) United States
(12) Patent Application Publication
(10) Pub. No.: US 2020/0356636 A1
(43) Pub. Date: Nov. 12, 2020

(54) CONTINUUM DICTIONARY GENERATOR

(71) Applicant: William Ragland Watkins, Montgomery, TX (US)

(72) Inventor: William Ragland Watkins, Montgomery, TX (US)

(21) Appl. No.: 16/409,782

(22) Filed: May 11, 2019

(51) Int. Cl. G06F 17/28; G06F 17/27

(52) U.S. Cl. CPC G06F 17/289; G06F 17/277; G06F 17/2795; G06F 17/2735

(57) ABSTRACT

Methods are disclosed for providing accurate translation between some languages and dialect-rich languages well as between dialects within dialect-rich languages. The present methods assign values to specific words within various dialect-rich languages and utilizes these values to perform specific and contextual matching to provide accurate specific meaning based translations.

### CROSS REFERENCE TO RELATED APPLICATIONS

This application claims the benefit of U.S. Provisional Patent Application Ser. No. 62/711,211 filed 27 Jul. 2018. The disclosure of the application above is incorporated herein by reference in its entirety.

### BACKGROUND OF THE INVENTION

### Field of the Invention

The present invention relates to a system and method of a language continuum and more particularly, to context based systems and methods for dialect language harmonization.

### Description of the Related Art

An important aspect of automatic speech recognition (ASR) systems is the ability to distinguish between dialects in order to properly identify and recognize speech in acoustic data. However, current solutions train ASR systems using all available acoustic data, regardless of the type of accent or dialect employed by the speaker. It is accepted that a dialect is a particular form of a language group that is peculiar to a specific region or social group. A useful metric in defining a dialect is a set settlement languages that share 90% of vocabulary and 75% of the exact meanings of that vocabulary. With regard to Arabic speech recognition in particular, most recent work has focused on recognizing Modem Standard Arabic (MSA). The problem of recognizing dialectal Arabic has not been adequately addressed. Arabic dialects differ from MSA and each other morphologically, lexically, syntactically, phono-logically and, indeed, in many dimensions of the linguistic spectrum. Heretofore there has been an effort in providing tools to enable words from one language to be translated into another language. Still other efforts have focused on the effect that dialects on accurate translations. Many of these efforts focus on data mining, computer generated statistical analyses and machine learning of published languages such as those set forth in US20170011739 and US20150287405, both of which are incorporated herein in their entirety. Certain languages, such as Arabic, Cantonese and others, are comprise of dialects from various countries, regions, cities, and villages that contain homophones (words that have the same spelling or structure but have different meanings). Many of these dialects lack sufficient written records to allow for the machine based translation methods of the prior art to provide accurate translations. This problem is well addressed in the publication titled “A Machine Translation of Arabic Dialects Arabic” by Rabih Zbib et al, also incorporated herein in its entirety.

Still using Arabic as an example, the lack of general knowledge about the content of the Arabic dialects has been limited by to the use of the formal language MSA which is virtually absent from everyday speech. The lack of specific knowledge about available vocabulary has been limited by a lack of written definition of Arabic dialect and overlapping vocabulary having differences (from large to subtle) in semantics that limits the recording of dialect vocabulary. If words could be both recorded and categorized by dialect, new markets could emerge such as the Colloquial Arabic language learning industry, sources, dictionaries, and applications, including Colloquial Arabic online content. It is important to note that the lack of online dialect specific content that prevents above mentioned and statistical machine translation processes.

Translating across Arabic dialects, as well as other dialect-rich languages can often be inaccurate and confusion using prior art methods, such as a conventional dictionary, or electronic methods such as an electronic translator. Arabic dialects, and two distinct dialects of other languages, can have problems not only in homophones in general, but in some specific homophones. For instance, in English there are the words “bear” as in “the big fuzzy animal” and there is also “bear” as in “to yield a weapon” (“to bear arms”). These words should not be a problem to use a dictionary or an electronic translator when translated into or out of English. The spelling and pronunciation doesn't stop a clear, concise definition of each to make the difference between the two uses of the word obvious. But unlike in English, Arabic and other dialect-rich languages are filled not just with homophones, but homophones with minute differences therebetween and overlapping meanings. Minute differences between two distinct dialects' identically spelled word necessitates any definitions of the words to be explicit enough not only to define the word, but so that the reader or user knows what the meaning of the word is not. Imagine if a first dialect word of English used “bear” in both of the ways that are used directly herein above, and another second English dialect used “bear” to mean “bear arms/weapons . . . but really only as in for hunting bears”, and a third English dialect's “bear” meant “to bear weapons but only in the sense that the user means to use the weapon non-lethally”, and yet a fourth English dialect's use of the word “bear” meant “non-lethal weapon”. Continuing with this example, then imagine that someone from the first dialect says “The protestors will bear arms” (as in, bear any kind of weapon) to mean “bear arms” to the third dialect speaker who thinks it only means “non-lethal”. The third dialect speaker wouldn't realize he had misunderstood the story (thinking an upcoming confrontation will be only with non-lethal weapons, yet guns are actually to be used in a lethal manner), while the first dialect speaker would not realize he had been misunderstood. If or when the misunderstanding is realized, the explanation can be obtuse and confusing, especially since neither speak the dialect of the other perfectly. If one were to use an electronic translator, the definitions would have to be detailed enough to not only make the “yield a weapon clear” but so that the person in need knows that it is not simply “bear any weapon”.

However, the problem of contextual recognition of dialectal languages has not been adequately addressed. What is needed is a is system and methods for producing contextually accurate translations between different dialects of the same language.

### SUMMARY OF THE INVENTION

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer-implemented method a continuum translation for a plurality of dialects, including at a computer having one or more processors and non-volatile memory for storing programs and to be executed by the one or more processors, entering an input word from a first region having an input word spelling, at least one input word definition and a first dialect, selecting a second region where the second region includes a second dialect, assigning a High SpeVal to the input word, matching the High SpeVal to at least one Low SpeVal, identifying at least one second dialect word having a second dialect word definition and a second dialect word spelling in dependence of the at least one Low SpeVal, comparing the input word definition for equality to the second dialect word definition the at least one second dialect word, comparing the second dialect word spelling of the at least one second dialect word for equality to the input word spelling; and outputting any of at least one identical word in the second dialect when the input word definition and the input word definition are equal to the second dialect word definition and the second dialect word spelling is equal to the second dialect word spelling of the at least one second dialect word, at least one similar word in the second dialect when the input word definition and the input word definition are equal to the second dialect word definition and the second dialect word spelling is not equal to the second dialect word spelling of the at least one second dialect word, and at least one conflicting word when the input word definition and the input word definition are not equal to the second dialect word definition and the second dialect word spelling is not equal to the second dialect word spelling of the at least one second dialect word. Other embodiments of this aspect include corresponding computer systems, apparatus, and computer programs recorded on one or more computer storage devices, each configured to perform the actions of the methods.

Implementations may include one or more of the following features. The computer-implemented method further includes identifying at least one context sentence associated with the High SpeVal in the first dialect, outputting the at least one context sentence, matching a specific context sentence from the at least one context sentence in dependence of a predetermined meaning, matching of the High SpeVal to the at least one Low SpeVal is in dependence of the specific context sentence and the High SpeVal, identifying at least one similar context sentence associated with the at least one similar word in the second dialect, comparing the specific context sentence with the at least one similar context sentence; and outputting any of at least one alternative word from the at least one similar word when the specific context sentence is substantially similar to the at least one similar context sentence and at least one conflicting word from the at least one similar word when the specific context sentence is not substantially similar to the at least one similar context sentence. The computer-implemented method further includes creating a first database including a plurality of first dialect words from the first dialect, creating a second database including a plurality of second dialect words from the second dialect, creating a third database including at least one High SpeVal for each of the plurality of first dialect words in the first database and each of the plurality of second dialect words from the second dialect, creating a fourth database including at least one Low SpeVal for each of the plurality of first dialect words in the first database and each of the plurality of second dialect words from the second dialect, creating a fifth database including at least one context sentence for each of the plurality of first dialect words in the first database, creating a sixth database including at least one context sentence for each of the plurality of second dialect words in the second database, creating a seventh database including at least one definition for each of the plurality of first dialect words in the first database, creating an eighth database including at least one definition for each of the plurality of second dialect words in the second database. The computer-implemented method further including populating at least a portion of the second database, the third database, the fourth database, the sixth database and the eighth database using a plurality of human speakers of the second dialect. The computer-implemented method may also include populating at least a portion of the first database, the third database, the fourth database, the fifth database and the seventh database using a plurality of human speakers of the first dialect. The computer-implemented method where at least a portion of the populating is any of crowd sourcing, translation software and machine learning. The computer-implemented method where the at least one High SpeVal includes a unique High SpeVal identifying computer code for each of the plurality of first dialect words in the first database and each of the plurality of second dialect words from the second dialect. The computer-implemented method where the at least one Low SpeVal includes a unique unique Low SpeVal identifying computer code for each of the at least one High SpeVal. The computer-implemented method where the at least one context sentence is further associated with the unique High SpeVal identifying computer code. The computer-implemented method where the at least one context sentence is further associated with the unique Low SpeVal identifying computer code. The method where the first dialect and the second dialect are two distinct dialects from a common language group. The method where the first dialect is from a first language group and the second dialect is from a second language group. Implementations of the described techniques may include hardware, a method or process, or computer software on a computer-accessible medium.

One general aspect includes a computer system, including one or more processors; and memory having instructions stored thereon, which when executed by the one or more processors cause the processors to perform operations, the operations include inputting an input word from a first region having an input word spelling, at least one input word definition and a first dialect, selecting a second region where the second region includes a second dialect, assigning a High SpeVal to the input word, matching the High SpeVal to at least one Low SpeVal identifying at least one second dialect word having a second dialect word definition and a second dialect word spelling in dependence of the at least one Low SpeVal, comparing the input word definition for equality to the second dialect word definition the at least one second dialect word, comparing the second dialect word spelling of the at least one second dialect word for equality to the input word spelling; and outputting any of at least one identical word in the second dialect when the input word definition and the input word definition are equal to the second dialect word definition and the second dialect word spelling is equal to the second dialect word spelling of the at least one second dialect word, at least one similar word in the second dialect when the input word definition and the input word definition are equal to the second dialect word definition and the second dialect word spelling is not equal to the second dialect word spelling of the at least one second dialect word, at least one conflicting word when the input word definition and the input word definition are not equal to the second dialect word definition and the second dialect word spelling is not equal to the second dialect word spelling of the at least one second dialect word. Other embodiments of this aspect include corresponding computer systems, apparatus, and computer programs recorded on one or more computer storage devices, each configured to perform the actions of the methods.

Implementations may include one or more of the following features. The computer system further includes identifying at least one context sentence associated with the High SpeVal in the first dialect, outputting the at least one context sentence, matching a specific context sentence from the at least one context sentence in dependence of a predetermined meaning, where matching of the High SpeVal to the at least one Low SpeVal is in dependence of the specific context sentence and the High SpeVal. The computer system further includes identifying at least one similar context sentence associated with the at least one similar word in the second dialect, comparing the specific context sentence with the at least one similar context sentence; and outputting any of, at least one alternative word from the at least one similar word when the specific context sentence is substantially similar to the at least one similar context sentence, at least one conflicting word from the at least one similar word when the specific context sentence is not substantially similar to the at least one similar context sentence. Implementations of the described techniques may include hardware, a method or process, or computer software on a computer-accessible medium.

One general aspect includes a non-transitory computer-readable medium, having instructions stored thereon, which when executed by one or more processors cause the processors to perform operations, the operations include inputting an input word from a first region having an input word spelling, at least one input word definition and a first dialect, selecting a second region where the second region includes a second dialect, assigning a High SpeVal to the input word, matching the High SpeVal to at least one Low SpeVal, identifying at least one second dialect word having a second dialect word definition and a second dialect word spelling in dependence of the at least one Low SpeVal, comparing the input word definition for equality to the second dialect word definition the at least one second dialect word, comparing the second dialect word spelling of the at least one second dialect word for equality to the input word spelling; and outputting any of, at least one identical word in the second dialect when the input word definition and the input word definition are equal to the second dialect word definition and the second dialect word spelling is equal to the second dialect word spelling of the at least one second dialect word, at least one similar word in the second dialect when the input word definition and the input word definition are equal to the second dialect word definition and the second dialect word spelling is not equal to the second dialect word spelling of the at least one second dialect word, at least one conflicting word when the input word definition and the input word definition are not equal to the second dialect word definition and the second dialect word spelling is not equal to the second dialect word spelling of the at least one second dialect word. Other embodiments of this aspect include corresponding computer systems, apparatus, and computer programs recorded on one or more computer storage devices, each configured to perform the actions of the methods.

Implementations may include one or more of the following features. The non-transitory computer-readable medium further includes identifying at least one context sentence associated with the High SpeVal in the first dialect. The non-transitory computer-readable medium may also include outputting the at least one context sentence. The non-transitory computer-readable medium may also include matching a specific context sentence from the at least one context sentence in dependence of a predetermined meaning. The non-transitory computer-readable medium may also include where matching of the High SpeVal to the at least one Low SpeVal is in dependence of the specific context sentence and the High SpeVal. The non-transitory computer-readable medium further includes identifying at least one similar context sentence associated with the at least one similar word in the second dialect. The non-transitory computer-readable medium may also include comparing the specific context sentence with the at least one similar context sentence; and outputting any of. The non-transitory computer-readable medium may also include at least one alternative word from the at least one similar word when the specific context sentence is substantially similar to the at least one similar context sentence. The non-transitory computer-readable medium may also include at least one conflicting word from the at least one similar word when the specific context sentence is not substantially similar to the at least one similar context sentence. Implementations of the described techniques may include hardware, a method or process, or computer software on a computer-accessible medium.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an illustration of a continuum dictionary generator system of the present disclosure;

FIG. 2 is a flow chart representing a continuum dictionary generator of the present disclosure;

FIG. 3 is a flow chart representing a continuum dictionary generator of the present disclosure;

FIG. 4 is a flow chart representing a specific step of a continuum dictionary generator of the present disclosure;

FIG. 5 is a flow chart representing a specific step of a continuum dictionary generator of the present disclosure;

FIG. 6 is a flow chart representing a specific step of a continuum dictionary generator of the present disclosure;

FIG. 7 is a flow chart representing a specific step of a continuum dictionary generator of the present disclosure;

FIG. 8 is a flow chart representing a specific step of a continuum dictionary generator of the present disclosure;

FIG. 9 is a flow chart representing a specific step of a continuum dictionary generator of the present disclosure;

FIG. 10 is a flow chart representing a specific step of a continuum dictionary generator of the present disclosure;

FIG. 11 is a flow chart representing a specific step of a continuum dictionary generator of the present disclosure;

FIG. 12 is a flow chart representing a specific step of a continuum dictionary generator of the present disclosure;

FIG. 13 is a flow chart representing a specific step of a continuum dictionary generator of the present disclosure;

FIG. 14 is a flow chart representing a specific step of a continuum dictionary generator of the present disclosure;

FIG. 15 is a flow chart representing a specific step of a continuum dictionary generator of the present disclosure;

FIG. 16 is a flow chart representing a specific step of a continuum dictionary generator of the present disclosure;

FIG. 17 is a flow chart representing a specific step of a continuum dictionary generator of the present disclosure;

FIG. 18 is a flow chart representing a specific step of a continuum dictionary generator of the present disclosure;

FIG. 19 is a flow chart representing a specific step of a continuum dictionary generator of the present disclosure; and

FIG. 20 is a flow chart representing a specific step of a continuum dictionary generator of the present disclosure.

### DETAILED DESCRIPTION

In the following detailed description of the embodiments, reference is made to the accompanying drawings, which form a part hereof, and within which are shown by way of illustration specific embodiments by which the examples described herein may be practiced. It is to be understood that other embodiments may be utilized and structural changes may be made without departing from the scope of the disclosure.

The examples disclosed herein relate to a continuum dictionary generator (CDG) to provide contextual continuity between dialects of a common language group. In many of the examples the Arabic language is used, however, the systems and methods of the present disclosure are equally useful in other languages having similar dialect issues as those described herein above and are considered part of the present disclosure. In accordance with the present disclosure words are recorded contextually based on their regional meaning, be that cities or settlements. The words are identified by these regions and entered into the CDG wherein the relationships between vocabulary and the meaning of each word of each settlement (or city) can be known. The method pf the present disclosure can be performed at a computer having one or more processors and memory for storing programs to be executed by the one or more processors.

The CDG of the present disclosure is based on the recognition that some words in any particular language are homophones, the same structural word used for multiple meanings. The CDG resolves these similarities and differences by being based on “Specific Values” or “SpeVals”, that is, a sort of micro word, wherein values are assigned to specific words and their single regional meanings. A SpeVal, for example, is a specific meaning of a word; treating the word “country” as referring to a nation, and its homophone “country” as referring to a rural area, as two different values. The system and methods of the present disclosure utilizes SpeVals to identify overlaps in vocabulary that diverge slightly in semantics. In certain embodiments this is done by maintaining a single dictionary of SpeVals used for all languages, while every language and dialect is assigned its own dictionaries, or databases, of words, definitions, and context sentences. The CDG uses both standard definitions and standardized context sentences to determine the slight dialect differences in meaning amongst words. The CDG of the present disclosure assigns SpeVals to “contrasts” or “relationships”. The SpeVals are placed in a database that is equally separate from all dialects and languages, and act as the means of relating these languages by using specific meanings, not words, as the base unit of the CDG. This is critical for dialects of languages that have evolved using the same words for different uses, but might still share one or two meanings due to their shared origin. For instance, in a traditional translation dictionary from English, “Country” in Algeria (“Balad”) is set to equal “Balad” in Cairo, regardless of differences in specific uses, the CDG would NOT say “Country=Balad”—instead, “Country”=different definitions, indicated by the SpeVals, indicating that this is a conflicting word. In this example, if “SpeVal A1=rural area outside of a town” and “SpeVal A2=nation or state”, and “SpeVal A3=hometown” then “Balad (of the Algiers database)=A1+A2+A3”. In to database for SpeVals for Cairo, “Balad=A1+A2”. It should be noted that, for avoidance of mistake and analyzing the data, the present disclosure includes High SpeVals and Low SpeVals. By way of example, a word native to a specific city is itself assigned a “High SpeVal” (for Algiers “balad”=“5R”, and for Cairo “balad”=“7P”) in the form of with the unique High SpeVal identifying computer code, which itself is set equal to specific SpeVals (like A1, A2, etc.—which we now refer to as “Low SpeVals”) in the form of a unique Low SpeVal identifying computer code. Continuing this example, if “5R=A1+A2+A3”, and “7P=A1+A2”, then “5R DOESN”T=7P”—that is to say, the Algerian “balad” doesn”t equal the Cairene “balad”. But, “5R=7P-A3”—that is to say, ““Balad” in Algiers is different from “balad” in Cairo in that the former can also be used to refer to “hometown” and the latter cannot”. This method is useful not only for immediate translation, which the specific and general search functions offer as described herein below, and mapping dialects. Further the present disclosure provides for the production of foreign language dialectical dictionaries and language learning material that pinpoint the specific ways one word, though sharing spelling and some meanings, is different from another dialect.

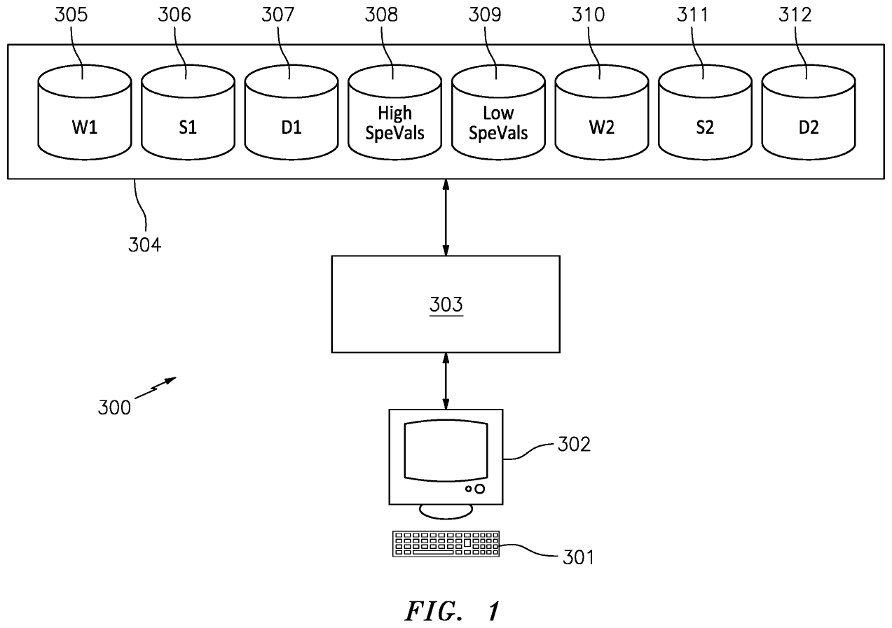

Referring to FIG. 1 there is shown an example of a computer system in the form of CDG 300 of the present disclosure comprising a user input device 301, a graphical interface 302, an application processor 303, a set of databases 304 comprising a first dialect words database 305, a first dialect context database 306, a first dialect definition database 307, a High SpeVal database 308, a Low SpeVal database 309, a second dialect words database 310, a second dialect context database 311 and a second dialect definition database 312. Databases 305-312 can comprise any known type of databases and can comprise a non-transitory computer-readable medium. User input device 301 and a graphical interface 302 are shown as a conventional keyboard and monitor but they can comprise any known type user devices including speech recognition, tablet, smartphone, speakers and the like. Although user input device 301, a graphical interface 302, processor 303 and databases 304 are shown as separate devices in electronic communication, they could be combined in various forms without departing from the present disclosure. Processor 303 can comprise one or more of any known computing device capable of performing the operations of executing computer code in the manner describe herein below and can be located local to user input device 301 and a graphical interface 302, remote therefrom or cloud based. Databases 304 can comprise any know accessible memory type including non-volatile and non-transitory memory.

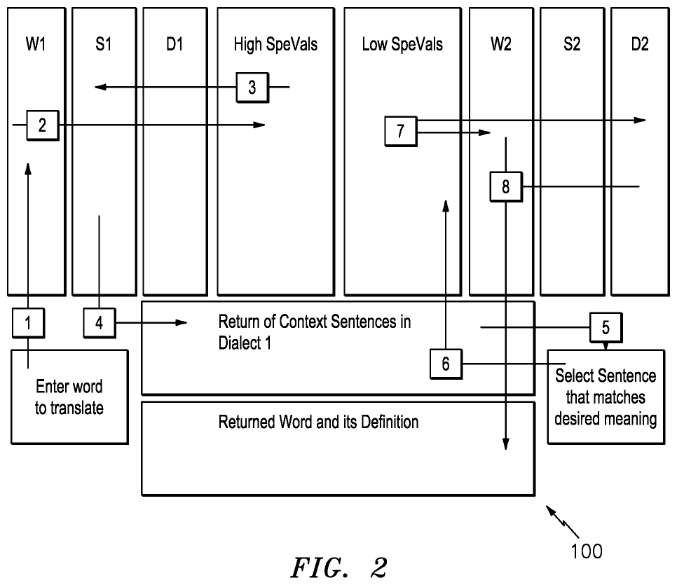

While still referring to FIG. 1 generally and now referring to FIG. 2 specifically, an embodiment of a specific search of the present disclosure is set forth in terms of its representative architecture. The operation of specific search 100 will be described herein below with reference to FIG. 2 between a first dialect and a second dialect of the same language. The following is a description of the abbreviations in FIG. 2:
“W1”=word database for dialect 1 (305)
“S1”=context sentence database for dialect 1 (306)
“D1”=definition database for dialect 1 (307)
“High SpeVals”=database of High SpeVals (308)
“Low SpeVals”=database of Low SpeVals (309)
“W2”=word database for dialect 2 (310)
“S2”=context sentence database for dialect 2 (311)
“D2”=definition database for dialect 2 (312)
   The word databases W1, W2, contextual databases S1, S2, as well as the definitional databases D1, D2 can all be populated by native human speakers of the specific dialects. This can be accomplished by crowd sourced activities such as those offered by Amazon Mechanical Turk. A portion of the databases can also be populated by other means such as prior art translation software and machine learning. The databases 304 may be stored in any known computer storage medium, including non-volatile and non-transitory memory, and the tasks outlined herein below can be performed by any known computing devices including one or more processors 303. At Step 1, using user input device 301, a user enters an input word and the city (or region or settlement) from which the word originates (“dialect 1”) and the user further selects the city for which the translation, or output word, is desired (“dialect 2”). At step 2, using processor 303, the input word entered by the user is located in word database W1 305 of dialect 1. At step 3, the with the unique High SpeVal identifying computer code of the input word and the output word is located in the High SpeVal database 302. At step 4, the context sentences of the High SpeVal in dialect 1 are located in the context database S1 306 and the context sentences of the input word of dialect 1 are returned to the user at graphical interface 302. At step 5, using user input device 301 the user selects the context sentence(s) that best fits the meaning(s) the user wants translated. At step 6, the a unique Low SpeVal identifying computer code associated with the selected context sentence(s) is/are located in the Low SpeVal database 309 using processor 303. At Step 7, the word and definition linked to the selected Low SpeVal are located in their respective dialect 2 databases W2 310, D2 312. In some embodiments the definition, while describing the dialect 2 word, will be delivered to the user in dialect 1 (ostensibly a dialect the user understands) with other embodiments including other languages such as English, and others. At step 8, the output word, or returned word, along with its dialect 2 definition associated with the specific SpeVal are returned to the user via graphical interface 302.

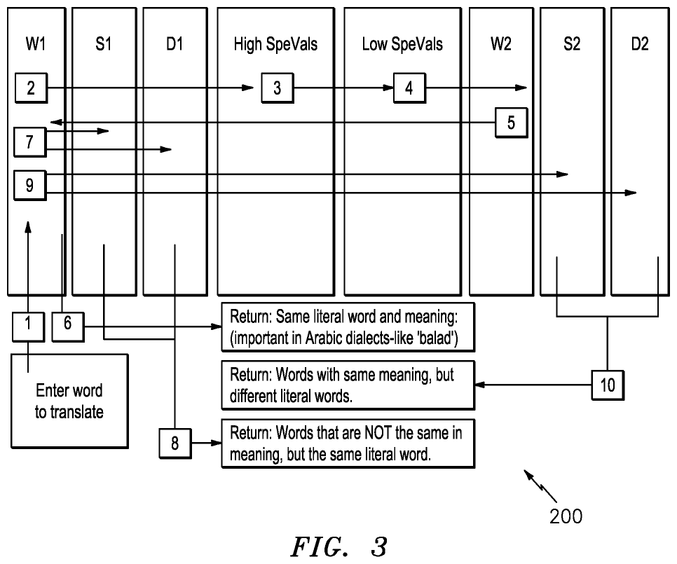

Still referring to CDG 300 of FIG. 1 generally and with specific reference to FIG. 3, there is shown an architectural representation of the general search function 200 of CGD in accordance with embodiment of the present disclosure. At step 1, using user input device 301 a user enters an input word and selects which a region from which it originates and further selects from which regional dialect the user would like it translated. The input word entered by the user is located by processor 303 in the word database W1 305 of dialect 1. At step 2, the High SpeVal of the input word, linked to its location in the database W1 305, is located by processor 303 by that link in the High SpeVals database 308. At step 3, the individual SpeVals linked to the selected High SpeVal are located by processor 303 in the Low SpeVals database 309. At step 4, the dialect 2 words for each of the located Low SpeVals are located by processor 303 in the W2 database 310. At step 5, using the dialect 2 database W2 310 the dialect 2 words for each Low SpeVal are tested by processor 303 for equality against the word database W1 305 for dialect 1 for the input word entered and searched for by the user. At step 6, for those words of dialect 2 that test equal in spelling, and they would all would be equal in meaning because they all share the same SpeVals, the matching word(s) is (are) returned to the user via graphical interface 302 as indicated. At step 7, for those dialect 1 words that do not test equal dialect 2 words in form but do test equal in meaning, they are compared by processor 303 to database 311 for those SpeVals context sentences in S1 306 and associated definitions D1 305. It is important to note that this step allows a user to know not to use whatever words that are equal in form, and some meaning, in dialect 2 in the particular instances of meaning it does not share with the originally translated word of dialect 1. Like in the example presented above, the word “balad” is meant to be a country in both Algerian and Egyptian, the CDG 300 of the present disclosure at step 8 would inform the user via graphical interface 302 “not to use balad, in Egyptian, to refer to hometowns” as that usage occurs only in Algerian. In step 9 the CDG 300 presents the user via graphical interface 302 with those words located in step 7 in D1 305 and S1 306 with instructions to not use the dialect 2 word that is translated in these particular instances because those particular instances are meanings and contexts that the word refers to only in dialect 1. In cases where the words do not test equal in the two distinct dialects, the CDG 300, at Step 9, using processor 303 locates the appropriately linked dialect 1 context sentences and definitions in S1 306 and D1 305 respectively. In such cases, the context sentences and the definitions found in Step 9, in addition to the dialect 2 word that they are linked to, are returned to the user via graphical interface 302 in Step 10 as the alternate and more appropriate word to used.

The CDG 300 of the present disclosure can be more readily understood by way of the examples presented herein after wherein Arabic words are presented and further used in English sentences. In this first example the word “Yom”, wherein the plural form is “ayam” is explored. Yom is an Arabic word and a homophone in both a dialect native to Cairo and a dialect native to Algiers. In the Cairo dialect a first definition of Yom is different than that of the same word in Algiers and in Cairo can be defined as “a period of twenty-four hours as a unit of time, reckoned from one midnight to the next, corresponding to a rotation of the earth on its axis”. An appropriate contextual sentence in Cairo can be “The past few “ayam” I slept a lot”. In a second definition of the word Yom, the word is defined the same in Cairo as it is in Algiers and can be defined as “the current day” (similar to “today” in the English language). In this context the word is used with the definite article “al” or in Arabic “ [symbol] ” which is sensibly the equivalent of “this” or “the” in the English language. An appropriate contextual sentence can be “A1-yom was the best day of my life”. In the Algiers dialect the definition is the same as the second definition in the Cairo dialect and the contextual sentence would be the same. A second word in the dialect of Algiers is “Nhar”, wherein the plural form is “nharat”. In the Algiers dialect, the only a definition can be “a period of twenty-four hours as a unit of time, reckoned from one midnight to the next, corresponding to a rotation of the earth on its axis”. An appropriate contextual sentence (x1) for “nhar” (plural=“nharat”), since this is an identical word in meaning (and thus shares the same SpeVal) to the Cairene yom/ayam, the example sentence will also be identical: “The past few days (nharat) I slept a lot”.

In using the CDG of the present disclosure with the example given above and the user is a native Cairo speaker, or a user of any language wanted to see how to say the “yom” (“day” in Cairene), if it is used at all, in the dialect of Arabic spoken daily in the Algerian city of Algiers. Referring back to FIGS. 1, 2 and 3, dialect 1 corresponds to Cairene Arabic and the data contained in W1 305, S1 306, and D1 307. Dialect 2 corresponds to Algiers Arabic and the data in W2 310, S2 311, and D2 312. While this is merely an example, it is important to note that contextual sentences and definitions are included for every dialect that the CDG 300 of the present disclosure is coded to be displayed at graphical interface 302. For instance, in an embodiment of the present disclosure, a user can search for an Egyptian word, and if the embodiment is displayed in English, then the English version of the context sentences and definitions will be used. However, the language that is used is not relevant because the contextual sentences and definitions of the same meaning share the same SpeVal.

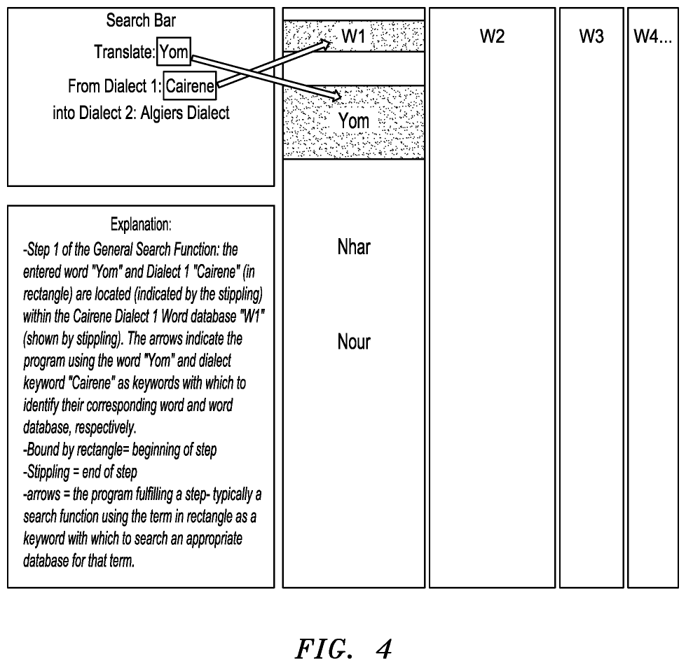

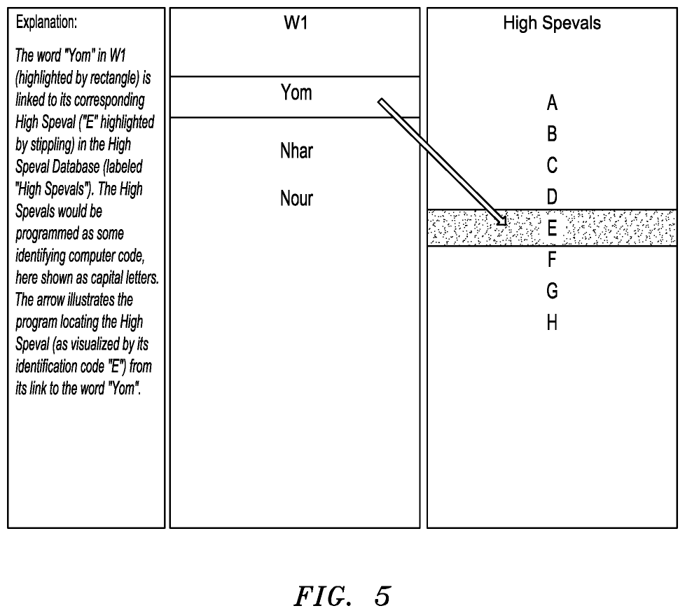

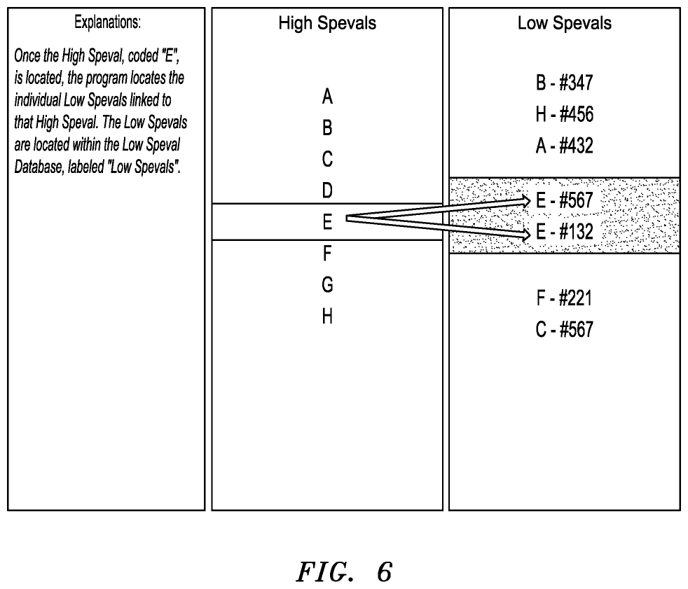

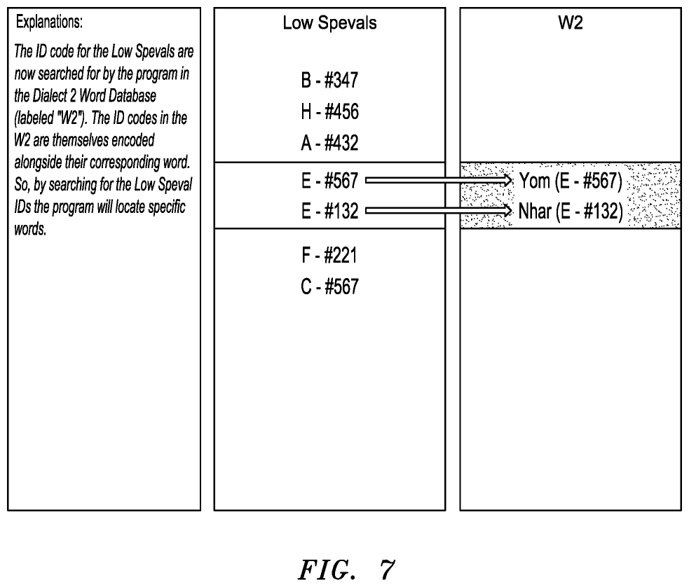

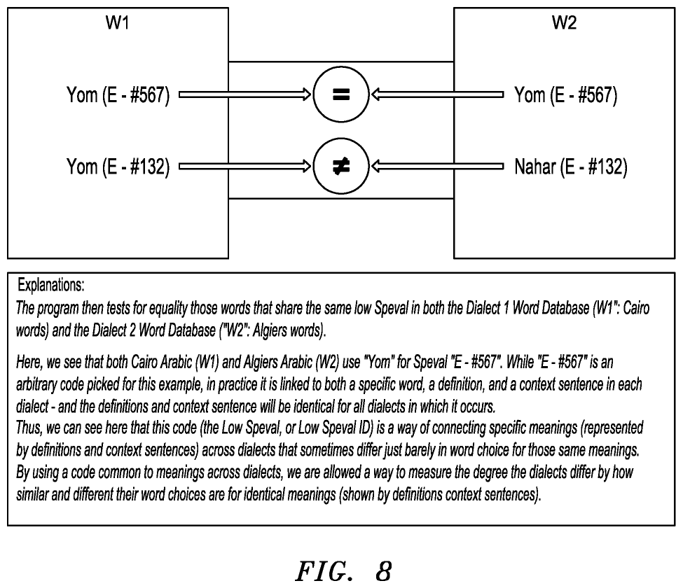

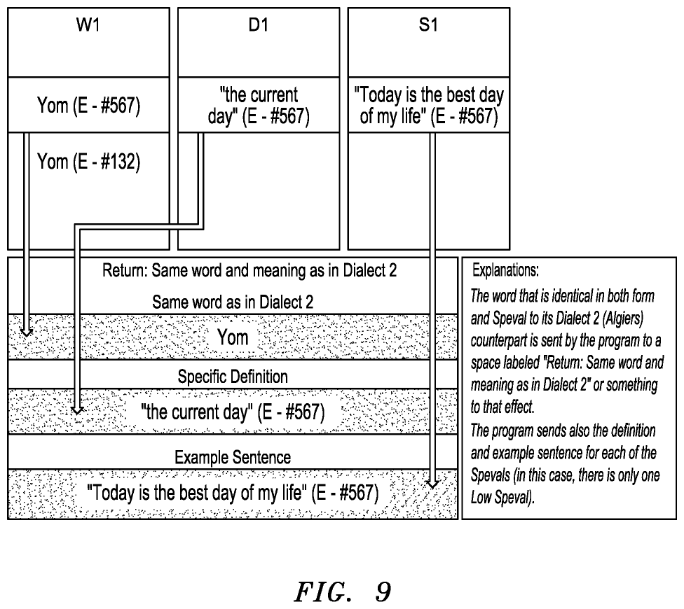

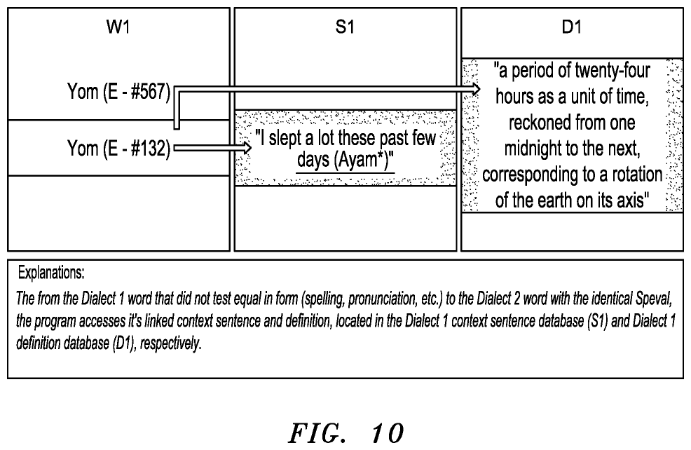

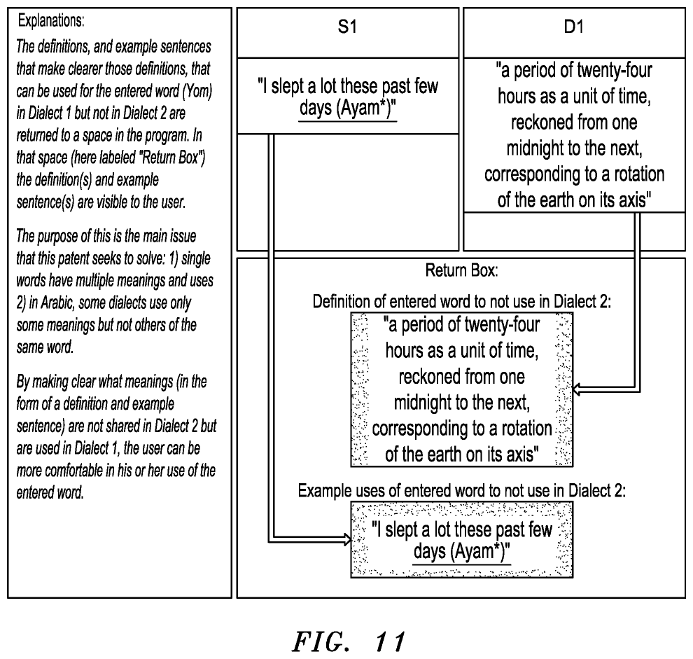

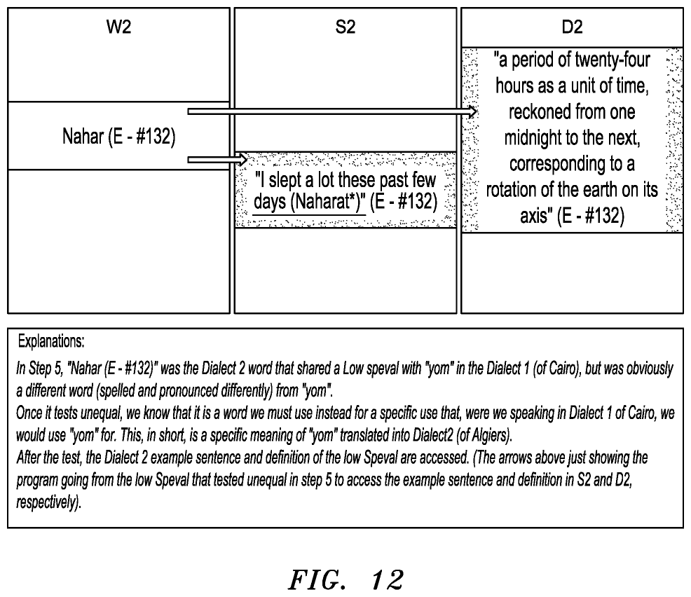

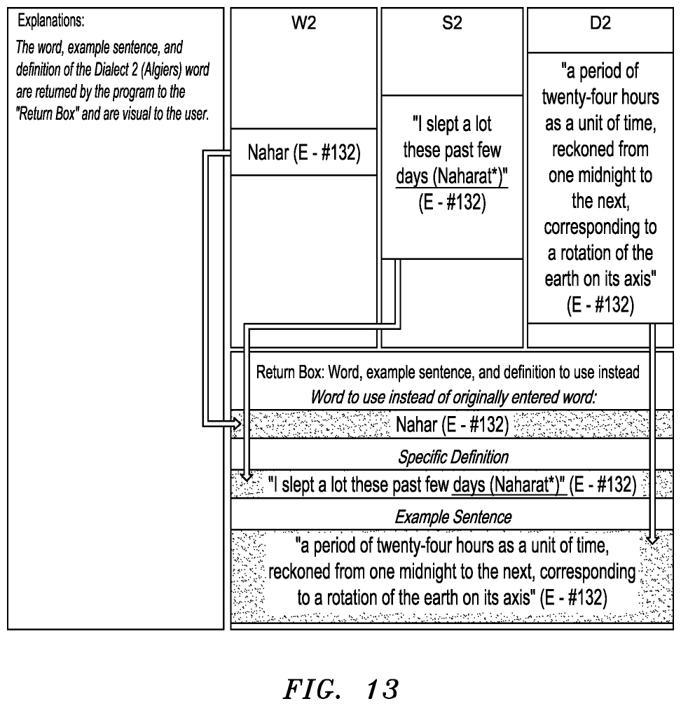

Referring back to FIGS. 1 and 3. and to the example given above for the word, “yom”, in Step 1, and now with reference to specific FIG. 4, a user enters word “yom” into the search bar (for example) of general search function 200 of CDG 300 and selects its original dialect (region, city, etc) in which it is known that yom is spoken (Cairo, or Cairene, in this example) and the user further selects the second dialect (Algiers, or Algerian, in this example) to determine the uses and translations for yom in the second dialect. It should be appreciated by those skilled in the art that due to the large amount of homographs in Arabic it normal for a user to assume that one dialect word exists in the other dialect. In Step 1, the input word “yom” is located in the word database “W1” of dialect 1 (Cairene). In Step 2, and with specific reference to FIG. 5, the High SpeVal of Yom, coded as “E” in this particular example, is located. In Step 3 using processor 303 the general search function 200 of CGD locates the individual Low SpeVals linked to that High SpeVal. The Low SpeVals are located within the Low SpeVal Database 309, labeled “Low SpeVals” within general search function 200 of CGD 300. In this particular example, the different Low SpeVals located are E-#567 and E-#132 as shown with and with specific reference to FIG. 6. The Low SpeVals are themselves essentially “ID codes” or “Identification codes” that, in the general search function 200 of embodied in processor 303 of CGD 100 (which may comprise computer coding or a written tangible version) that is also carried by a corresponding word, definition, and example sentence in all dialects in which the meaning it describes exists. In Step 4, and with and with specific reference to FIG. 7, of general search function 200 of CGD 300, using processor 303 the ID code for the Low SpeVals are searched for in the Dialect 2 Word Database W2 310. The ID codes in the W2 310 are themselves encoded alongside their corresponding word. It should be appreciated that by searching for the Unique Low SpeVal identifying computer codes within W2 310 of general search function 200 of CGD 300 specific words can be located by processor 303. In this particular example, the word containing E-#567 in W2 is “Yom” and the word containing E-#132 in W2 is “Nhar”. In Step 5 of general search function 200 of CGD 300, and with specific reference to FIG. 8, the equality of those words that share the same Low SpeVal in both the Dialect 1 Word Database (“W1”; Cairo words) is tested by processor 303, in programmed code for example, and the Dialect 2 Word Database (“W2”; Algiers words). Again, in this particular example, both Cairo Arabic (W1) and Algiers Arabic (W2) use “Yom” for the SpeVal “E-#567”. While “E-#567” is an arbitrary code picked for this example, in practice it is linked to both a specific word, a definition, and a context sentence in each dialect and the definitions and context sentences will be identical for all dialects in which it occurs. It should be noted that the Low SpeVal, or Unique Low SpeVal identifying computer code, is a means of connecting specific meanings (represented by definitions and context sentences) across dialects that sometimes differ just barely in word choice for those same meanings. By using a code common to meanings across dialects, general search function 200 of CGD 300 enables a way to measure the degree to which dialects differ by how similar and different their word choices are for identical meanings (shown by definitions and context sentences). With specific reference to FIG. 9, in Step 6 of general search function 200 of CGD 300, the word that is an identical word in both form and Low SpeVal to its Dialect 2 (Algiers) counterpart is identified and presented to the user, on graphical interface 302, as “Return: Same word and meaning as in Dialect 2”. The general search function 200 of CGD 300 can also provide the definition and example sentence for each of the SpeVals (in this case, there is only one low SpeVal). In Step 7 of general search function 200 of CGD 300, and with specific reference to FIG. 10, the word from the dialect 1 database W1 305 that did not test equal in form (spelling, pronunciation, etc.) to the dialect 2 word with the identical SpeVal, its linked context sentence and definition is located by processor 303 in the dialect 1 context sentence database S1 306 and dialect 1 definition database D1 307, respectively. With specific reference to FIG. 11, in Step 8 general search function 200 of CGD 300, the definitions, and example sentences that make clearer those definitions, that can be used for the entered word (yom) in dialect 1, but that do reflect the same meaning dialect 2, are identified by processor 303 and presented to the user on graphical interface 302. In this manner, general search function 200 of CGD 300 is novel in providing that in some languages, both single words have multiple meanings and uses and that (in this example Arabic) some dialects use only some meanings but not others of the same word. By making clear what meanings (in the form of a definition and example sentence) are not shared in dialect 2 but are used in dialect 1, the user can be more comfortable in the use of the entered word. In Step 9 of general search function 200 of CGD 300, and with specific reference to FIG. 12, and following from Step 5, “Nahar (E-#132)” was the dialect 2 word that shared a low SpeVal with “yom” in the dialect 1 (of Cairo) but was obviously a different word (spelled and pronounced differently) from “yom”. Because it tests as unequal by processor 303, we know that it is a word we must use instead for a specific use that, were we speaking in dialect 1 of Cairo, we would use “yom”. This, in short, is a specific meaning of “yom” translated into dialect 2 (of Algiers). After the test of Step 5 is performed by processor 303, the dialect 2 example sentence and dialect word definition of the low SpeVal are accessed by the processor to provide the example sentence and definition in S2 311 and D2 312, respectively. With specific reference to FIG. 13, in Step 10 of general search function 200 of CGD 300, the word, example sentence, and the dialect word definition of the Dialect 2 (Algiers) word are returned by the program to the “Return Box” and in the example of a graphical interface 302, can be visually presented to the user.

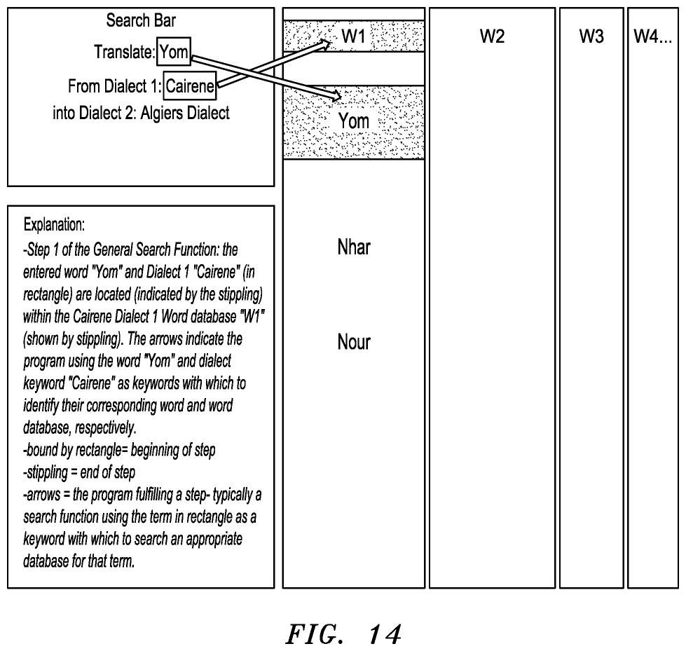

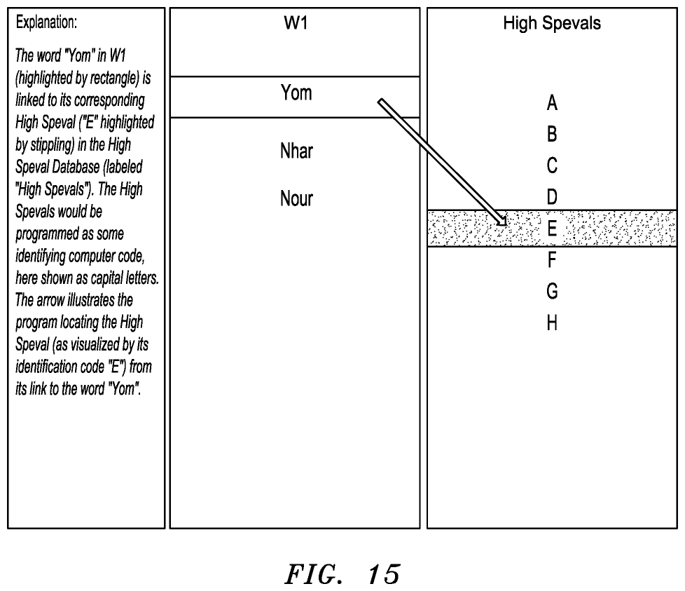

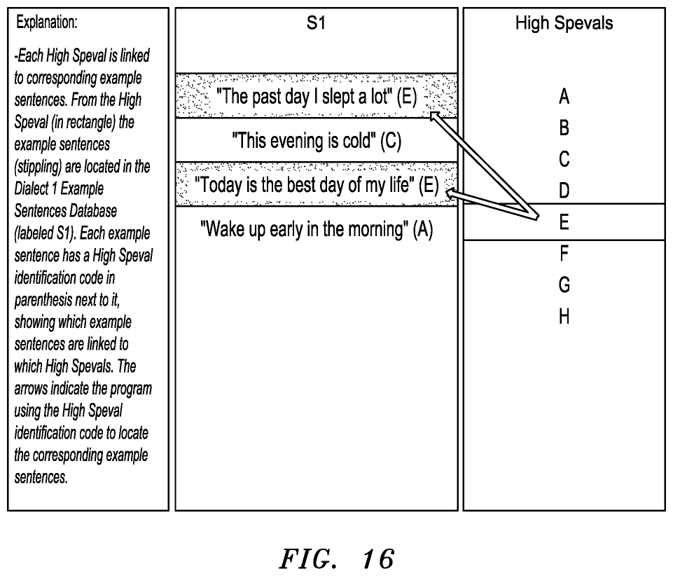

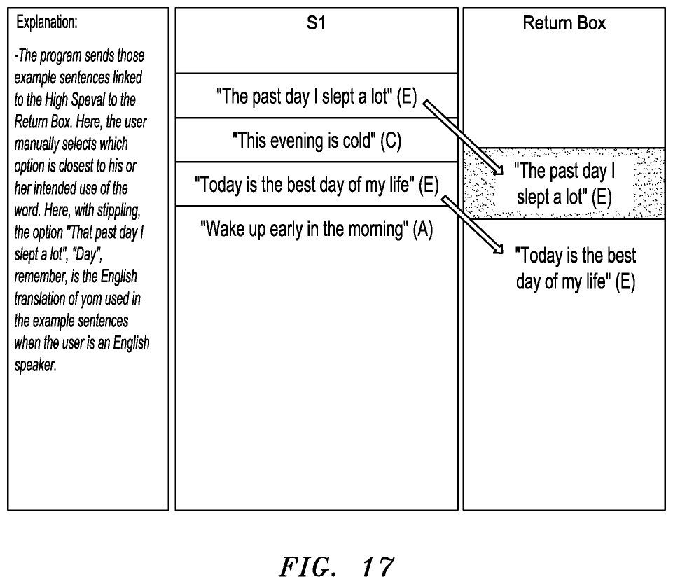

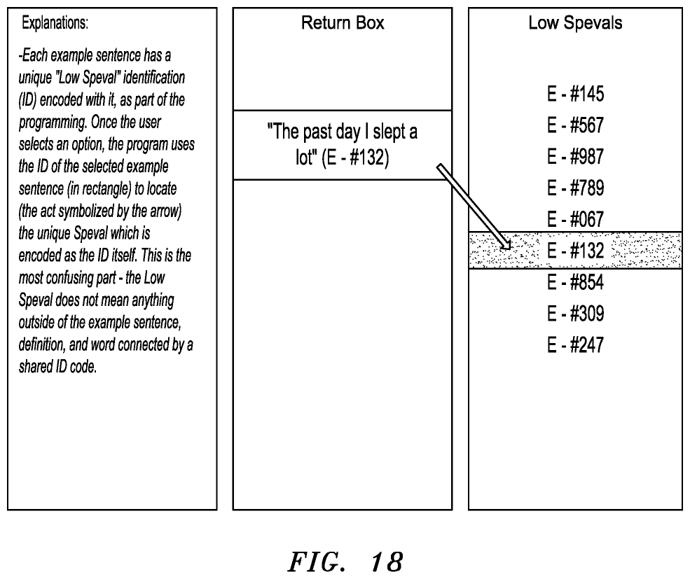

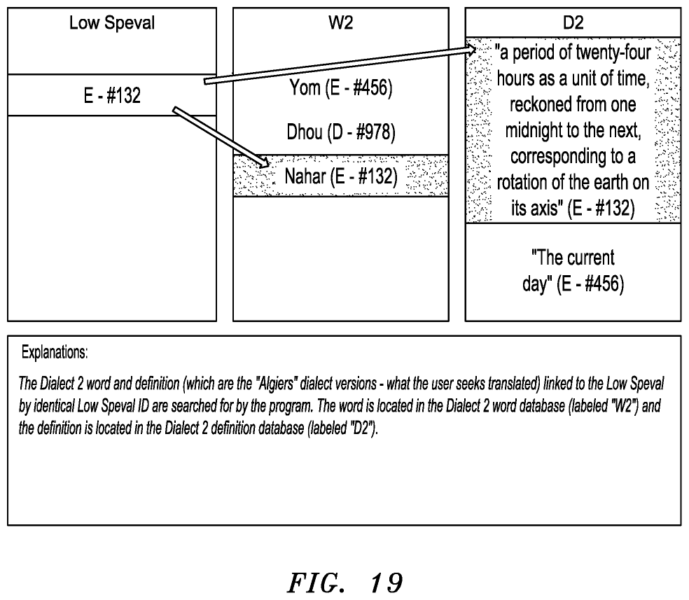

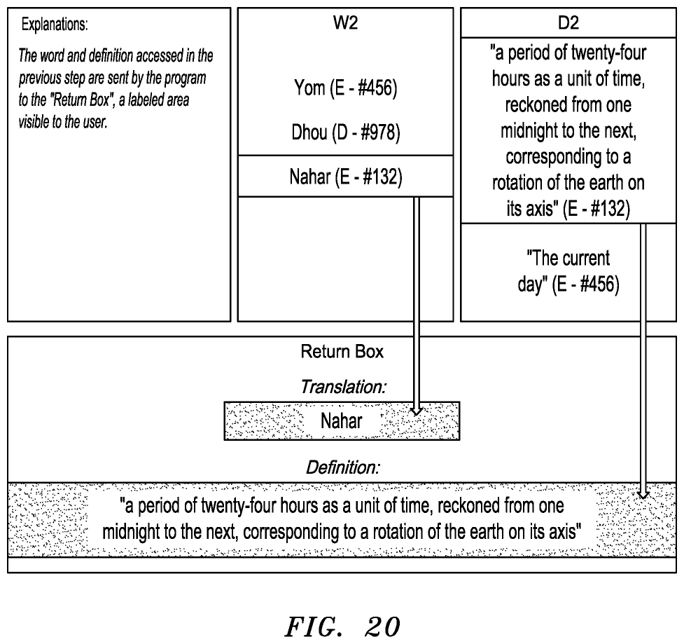

Now referring back to FIG. 2, and to the results of Step 1 of the general search 200 example given above for the word, “yom”, the operation of specific search 100 will be described. With further reference to FIG. 14, in Step 1 of the in specific search function 100 the entered word “Yom” and Dialect 1 Cairene” are located by processor 303 within the Cairene Dialect 1 Word database W1 305. The arrows indicate the process, using processor 303 for example, using the word “Yom” and dialect keyword “Cairene” as keywords with which to identify their corresponding word and word database, respectively. Referring now to FIG. 15, in Step 2 of specific search function 100, the word “Yom” in W1 305 is linked to its corresponding High SpeVal “E” in the High SpeVal Database 308. The High SpeVals can be programmed as some computer identifiable code, here shown as capital letters. The arrow illustrates the process locating the High SpeVal (as visualized by its identification code “E”) from its link to the word “Yom”. Step 3 of specific search function 100 is show with reference to FIG. 16 wherein, using processor 303, each High SpeVal is linked to corresponding example sentences. From the High SpeVal its identification code “E” the example sentences (“The past day I slept a lot” and “Today is the best day of my life”) are located in the Dialect 1 Example Sentences Database S1 306. Each example sentence has a unique High SpeVal identifying computer codeentification code in parenthesis next to it (E) in this example, showing which example sentences are linked to which High SpeVals. The arrows indicate the process using the Unique High SpeVal identifying computer codeentification code processor 303 is used to locate the corresponding example sentences. Referring now to FIG. 17, Step 4 comprises processor 303 sending the aforementioned example sentences linked to the High SpeVal to the Return Box, in the form of graphical interface 302, for the user to see in dialect 1. In Step 5 using user input device 301 the user can manually select which option is closest to the user's intended use of the word. Here, the option “The past day I slept a lot”. “Day”, as mentioned herein before, is the English translation of yom used in the example sentences when the user is an English speaker. In Step 6, as shown in FIG. 18, each example sentence has a unique “Low SpeVal” identification (ID) encoded with it, as part of the programming. Once the user selects an option, processor 303 uses the ID of the selected example sentence (“The past day I slept a lot”) to locate (the act symbolized by the arrow) the unique SpeVal which is encoded as the ID itself, which in this example is E-#132. It should be noted that the Low SpeVal has no meaning outside of the example sentence, definition, and word connected by a unique Low SpeVal identifying computer code. It should also be noted that “Yom” and “Dhou” can be viewed as alternative words that can be returned to the user. Referring now to FIG. 19, Step 7 involves the linking by processor 303 of the dialect 2 word and definition (which are the “Algiers” dialect versions—what the user seeks translated) linked to the Low SpeVal by identical unique Low SpeVal identifying computer code are searched for by the processor. The word is located in the dialect 2 word database W2 310 and the definition is located in the dialect 2 definition database D2 312. In Step 8, shown in FIG. 20, the word and definition accessed in the previous step are sent by processor 303 to the “Return Box”, to graphical interface 302, visible to the user.

The following examples are meant to further illustrate the general search function 200 and the specific search function 100 of CGD 300. The various steps of the method of the present disclosure refer to this found in the various figures as outlined herein above. In this example the word to be translated by the CGD 300 is “Next to them” and “side”. This particular word is “Ganbu” (used in both Cairo and Algiers for “side” and Cairo only for “next to”). In Cairo the definition for “Next (to)” could be “in or into a position immediately to one side of; beside.” and “Side” could be defined as “an upright or sloping surface of a structure or object that is not the top or bottom and generally not the front or back”. Similarly, in Algiers “Side” could be defined as “an upright or sloping surface of a structure or object that is not the top or bottom and generally not the front or back”. While the word “Hda” is used in Algiers for the meaning of “next to” having a definition of “in or into a position immediately to one side of; beside.”

In this particular example a user may have knowledge of Cairene Arabic (or are from Cairo) and desires to know how to say “Next” (the preposition—as in, “next to . . . ”) to be best understood by a native from Algiers. Referring to FIG. 2 and the specific search function 100 of CGD 300, in Step 1 using user input device 301 the user enters the word “Ganbu” (“next to” in Cairene”), and selects Cairo to show that you are referencing the Cairene form of the word (this is dialect 1). The user then selects ‘specific search’, and that the translation should be in the Algiers dialect (this is dialect 2). The word “Ganbu” is located by processor 303 in the word database for Cairo words W1 305.

In Step 2 the high SpeVal of “Ganbu” is then located by processor 303 in the High SpeVal database 308 from its link to the word “Ganbu” in W1 305. In Step 3 the high SpeVal of “Ganbu” is linked by processor 303 to the context sentences for each SpeVal (each specific meaning) that “Ganbu” is used for in the Cairo-Ganbu, as we see, is used for at least two meanings in Cairene:
For SpeVal meaning “next to”: “The chair was next to (Ganbu) the table, not behind it.”; and
For the SpeVal meaning “side”: “The side (Ganbu) of the building covered in graffiti.”

In Step 4 these two context sentences are returned by processor 303 to the user for the proper selection, as part of a graphical interface 302 or via a website through which a user can use the CDG 300. In Step 5 using user input device 301 the user then selects the context sentence which displays his or her intended use of the word, which in this particular example, desiring the meaning for “next to”, the user would select the first option. In Step 6 the low SpeVal of the selected context sentence is located by processor 303 in the low SpeVal database 309. In Step 7 the word and its definition used by the dialect 2 for that SpeVal are located by processor 303 in the dialect 2 word database W2 310 and definition database D2 312, respectively. In Step 8 the as described herein before, for Algiers, the word is “Hda” wherein Hda would be included with the returned results so the user can be sure they picked the right word, the definition would be the same appropriate definition of “side” in English (with any differences noted).

Referring back to FIGS. 1 and 3 and the general search function 200 of CGD 300, the user may desire to know the different words in Algiers Arabic in order to say all the uses (2 in this case) that “Ganbu” is used for in Cairene Arabic. In Step 1 using user input device 301 the user enters in the word “Ganbu” (“next to” in Cairene”), and selects Cairo to show that you are referencing the Cairene form of the word (this is dialect 1). The user then selects ‘general search’, and that the translation should be in the Algiers dialect (this is dialect 2). The word “Ganbu” is located by processor 303 in the word database for Cairo words W1 305 for dialect 1 and in Step 2 the high SpeVal of “Ganbu” is then located by the processor in the high SpeVal database 308 from its like to the word “Ganbu” in W1. In Step 3 each of the low SpeVals of linked to the high SpeVal are located by processor 303 in the low SpeVal database 309. In this case, these SpeVals are those linked to, in each dialect, the words and meanings representative of “side” and “next to”—both of which are represented by “Ganbu” in Cairene Arabic. In Step 4 each of the words in the Algiers word database W2 310 linked to those low SpeVals accessed in Step 3 are now accessed:
For the meaning “next to” Algiers uses “Hda”
For the meaning “side”, Algiers uses “Ganbu”.

In Step 5, the Algiers words for each of the two low SpeVals are tested for equality with the word used by the Cairene dialect:
SpeVal for “side(of something)”: “Ganbu” (in Cairene)=“Ganbu” (in Algiers)
SpeVal for “Next (to)” meaning: “Ganbu” (in Cairene)≠“Hda” (in Algiers)

In Step 6 the word(s) that do equal in form for the same SpeVal are returned to the user via graphical interface 302 and can be labeled “Same form and meaning” and in this particular example, “Ganbu” is returned, due to testing by processor 303 as an identical word to the Algiers form. Though not shown, the input word definition and context sentence of this word, according to the dialect 1 (Cairene) could also be returned from D1 305 and S1 306, respectively. In FIG. 3, the message shown on graphical interface 302 can be labeled “Return: Same literal word and meaning: (important in Arabic dialects—like ‘balad’)” for the user's review. The definition and context sentence of the dialect 1 word(s) that, in Step 5, did not test equal by processor 303 in form to the dialect 2 word of the same SpeVal are located in Step 7 and returned from D1 307 and S1 306, respectively, in Step 8. In this example, since the SpeVal (for words meaning “next(to)” in English) did not share the same word in both dialect 1 and dialect 2 (of course, in Cairene this is also represented by “Ganbu”), in Step 7 its context sentence and definition are located by processor 303 and in Step 8 are returned to graphical interface 302 and indicated that those word(s) that did not test equal to the user and can be labeled “Do NOT use ‘Ganbu’ for . . . ”.; other information can also be returned to the user in this case such as “Words that are NOT the same in meaning, but the same literal word”. In Step 9, the dialect 2 word(s) that did not test equal by processor 303 now have their example sentence(s) and definition(s) accessed in the dialect 2 (Algiers Arabic) context sentence database S2 311 and definition database D2 312, respectively. In this example, this word would be “Hda”, the Algiers word for the meaning of “next (to)” and the example sentence could be: “The chair was next to (Ganbu) the table, not behind it”. The dialect 2 word(s) (in Algiers Arabic) from Step 9, which does not share the same form (i.e., word or spelling) as its dialect 1 (Cairene) counterpart, can be returned to the user in Step 10, along with its definition and contest sentence, to graphical interface 302 and labeled “Use instead” or something to that effect. Dialect 2 word, “Hda”, in this case is returned along with the definition and context sentence

In this next example the word to be translated by the CGD 300 is “thing” in English; in Arabic it is “Haga”. It is used in both Cairo and Algiers for “an object that one need not, cannot, or does not wish to give a specific name to” but in the Algiers dialect “Haga” is used to refer to some unspecified noun, similar to how “anything” is used in English wherein these could be referred to as similar words. The Cairo dialect also uses the word for that meaning, in addition to the sense of specific objects someone has in mind, like “belongings, baggage, or stuff”. In this example a user may have knowledge of Cairene Arabic (or are from Cairo) and desires to know how to say “thing” (as in “belongings, baggage”) so that he could be understood while traveling in the city of Algiers. Referring to FIG. 2 and the specific search function 100 of CGD 300, in Step 1 using user input device 301 the user enters the word “Haga” (“thing, as in, possession or object” in Cairene”). The user also selects Cairo as dialect 1 to reference the Cairene form of the word. Then selecting ‘specific search’, the translation will be in the selected dialect 2, the Algiers dialect in this example. The word “Haga” is located by processor 303 in the Cairo W1 305 word database. The high SpeVal of “Haga” is then located by processor 303 in the High SpeVal database 308 from its link to the word “Haga” in W1 305. In Step 3 the high SpeVal of “Haga” is linked by processor 303 to the context sentences for each SpeVal that “Haga” is used for in the Cairo:
For SpeVal meaning “baggage”: “she began to unpack her things (Haga)”; and
For the SpeVal meaning “any general thing”: “she couldn't find a thing (Haga) to wear”

In Step 4 these two context sentences are returned to the user for the proper selection, as part of graphical interface 302 by processor 303 or a website through which a user can use the CDG 300. In addition, similar context sentences can be returned to the user as well. In Step 5 using user input device 302 the user then selects the context sentence which displays the meaning for “baggage”. In Step 6 that context sentences low SpeVal is located by processor 303 in the low SpeVal database S1 306. In Step 7 the word and its definition used by the dialect 2 (Algiers dialect) for that SpeVal are located by processor 303 in the dialect 2 word database W2 310 and definition database D2 312, respectively. In Step 8 the as described herein before, for Algiers, the word is “Durzan” wherein Durzan would be included with the returned results so the user can be sure they picked the right word, the definition would be the same appropriate definition of “side” in English (with any differences noted).

Referring to FIGS. 1 and 3 and the general search function 200 of CGD 300, the user may desire to know the different words in Algiers Arabic in order to say all the uses of “Haga” in Cairene Arabic. In Step 1 using user input device 301 the user enters in the word “Haga” and selects Cairo as dialect 1 to show that the user is referencing the Cairene form of the word. The user then selects Algiers to be dialect 2, and that the function being used is the ‘general search’. Then the word “Haga” is located by processor 303 in the word database for Cairo words W1 305. Following this, in Step 2 the high SpeVal of “Haga” is then located by processor 303 in the high SpeVal database 308 from its like to the word “Haga” in W1 305. Each of the low SpeVals (each respectively linked to the word, definitions, and context sentences of “general thing” and “specific belongings/baggage”) linked to the high SpeVal is then located by processor 303 in the low SpeVal database 309 in Step 3. Both meanings of “general thing” and “belongings or baggage” are encapsulated in by Haga in Cairo Arabic, but, as the previous specific function process has shown, Algiers Arabic uses Haga for one of these meanings. In Step 4 each of the words in the Algiers word database W2 310 linked to those low SpeVals accessed in Step 3 are now accessed by processor 303:
For the meaning “general thing” Algiers uses “Haga”
For the meaning “baggage”, Algiers uses “Durzan”.

In Step 5, the Algiers words for each of the two low SpeVals are tested by processor 303 for equality with the word used by the Cairene dialect:
SpeVal for “thing (baggage, stuff)” meaning: “Haga” (in Cairene)≠“Durzan” (in Algiers)
SpeVal for “thing (general unspecified object)”: “Haga” (in Cairene)=“Haga” (in Algiers)

Since “Haga” (for the meaning of general ‘thing’) tested identical by processor 303 to the Algiers form of the word, it is returned (along with its definition, from D1 305, and context sentence, from S1 306) to the user via graphical interface 302 under the label “same form and meaning” or something to that effect, as occurs with all such words in Step 6. In FIG. 3, this space is labeled “Return: Same literal word and meaning”. In Step 7, the definition and context sentence of the Cairene, dialect 1 (word(s) that did not test equal by processor 303 in form to the Algiers (dialect 2) word of the same SpeVal in this example, Cairo's word “Haga” with the definition of “belongings or baggage” are also dealt with. They are first located by processor 303 in D1 307 (the location of the definition) and S1 306 (the location of the context sentence), then, in Step 8, are returned via graphical interface 302 to a space for the user to view, which is labeled on the diagram “Words that are NOT the same in meaning, but the same literal word”. In this example, the definition (“thing (baggage, stuff)”) and the context sentence (“she began to unpack her things (Haga)”) of the form of “Haga” which did not share the same SpeVal as the Algiers form of Haga are returned to graphical interface 302. Upon their return, they also can be labeled “Do NOT use ‘Haga’ for . . . ”. instead of “Words that are NOT the same in meaning, but the same literal word” or another alternative, as long as the point that ‘this word in the user's dialect exists, but not for the specific use in question’ is communicated. In Step 9, the Algiers (dialect 2) word(s) that did not test equal by processor 303 then have their example sentence(s) and definition(s) located by the processor in the dialect 2 (Algiers Arabic) context sentence database S2 311 and definition database D2 312, respectively. In this example, “Durzan” (the city of Algiers dialect's word for “baggage” or “possession”) and the example sentence “she began to unpack her things (Durzan)” are accessed in D1 307 and S1 306 in Step 9, and are sent to graphical interface 302 which the user can view in Step 10. This message can be displayed as “Words with the same meaning, but different literal words”. The message can instead be displayed as “Use instead” or something to that effect. In this example, the just previously stated definition (“baggage” and context sentence (“she began . . . ”) are returned to graphical interface 302.

Furthermore, while the invention has been shown and described with respect to certain preferred embodiments, it is obvious that equivalent alterations and modifications will occur to others skilled in the art upon the reading and understanding of the specification. The present invention includes all such equivalent alterations and modifications, and is limited only by the scope of the appended claims.

While foregoing is directed to the preferred embodiment of the present invention, other and further embodiments of the invention may be devised without departing from the basic scope thereof, and the scope thereof is determined by the claims that follow.

What is claimed is:

1. A computer-implemented method of providing a continuum translation for a plurality of dialects, comprising:
at a computer having one or more processors and non-volatile memory for storing programs and to be executed by the one or more processors:
entering an input word from a first region having an input word spelling, at least one input word definition and a first dialect;
selecting a second region wherein the second region comprises a second dialect;
assigning a High SpeVal to the input word;
matching the High SpeVal to at least one Low SpeVal;
identifying at least one second dialect word having a second dialect word definition and a second dialect word spelling in dependence of the at least one Low SpeVal;
comparing the input word definition for equality to the second dialect word definition the at least one second dialect word;
comparing the second dialect word spelling of the at least one second dialect word for equality to the input word spelling; and
outputting any of:
at least one identical word in the second dialect when the input word definition and the input word definition are equal to the second dialect word definition and the second dialect word spelling is equal to the second dialect word spelling of the at least one second dialect word; and
at least one similar word in the second dialect when the input word definition and the input word definition are equal to the second dialect word definition and the second dialect word spelling is not equal to the second dialect word spelling of the at least one second dialect word; and
at least one conflicting word when the input word definition and the input word definition are not equal to the second dialect word definition and the second dialect word spelling is not equal to the second dialect word spelling of the at least one second dialect word.

2. The computer-implemented method of claim 1 further comprising:
identifying at least one context sentence associated with the High SpeVal in the first dialect;
outputting the at least one context sentence;
matching a specific context sentence from the at least one context sentence in dependence of a predetermined meaning; and
wherein matching of the High SpeVal to the at least one Low SpeVal is in dependence of the specific context sentence and the High SpeVal.

3. The computer-implemented method of claim 2 further comprising:
identifying at least one similar context sentence associated with the at least one similar word in the second dialect;
comparing the specific context sentence with the at least one similar context sentence; and
outputting any of:
at least one alternative word from the at least one similar word when the specific context sentence is substantially similar to the at least one similar context sentence; and
at least one conflicting word from the at least one similar word when the specific context sentence is not substantially similar to the at least one similar context sentence.

4. The computer-implemented method of claim 3 further comprising:
creating a first database comprising a plurality of first dialect words from the first dialect;
creating a second database comprising a plurality of second dialect words from the second dialect;
creating a third database comprising at least one High SpeVal for each of the plurality of first dialect words in the first database and each of the plurality of second dialect words from the second dialect;
creating a fourth database comprising at least one Low SpeVal for each of the plurality of first dialect words in the first database and each of the plurality of second dialect words from the second dialect;
creating a fifth database comprising at least one context sentence for each of the plurality of first dialect words in the first database;
creating a sixth database comprising at least one context sentence for each of the plurality of second dialect words in the second database;
creating a seventh database comprising at least one definition for each of the plurality of first dialect words in the first database; and
creating an eighth database comprising at least one definition for each of the plurality of second dialect words in the second database.

5. The computer-implemented method of claim 4 further comprising:
populating at least a portion of the second database, the third database, the fourth database, the sixth database and the eighth database using a plurality of human speakers of the second dialect.
populating at least a portion of the first database, the third database, the fourth database, the fifth database and the seventh database using a plurality of human speakers of the first dialect.

6. The computer-implemented method of claim 5 wherein at least a portion of the populating is any of crowd sourcing, translation software and machine learning.

7. The computer-implemented method of claim 4 wherein the at least one High SpeVal comprises a unique High SpeVal identifying computer code for each of the plurality of first dialect words in the first database and each of the plurality of second dialect words from the second dialect.

8. The computer-implemented method of claim 7 wherein the at least one Low SpeVal comprises a unique Low SpeVal identifying computer code for each of the at least one High SpeVal.

9. The computer-implemented method of claim 8 wherein the at least one context sentence is further associated with the unique High SpeVal identifying computer code.

10. The computer-implemented method of claim 9 wherein the at least one context sentence is further associated with the unique Low SpeVal identifying computer code.

11. The method of claim 1, wherein the first dialect and the second dialect are two distinct dialects from a common language group.

12. The method of claim 1, wherein the first dialect is from a first language group and the second dialect is from a second language group.

13. A computer system, comprising: one or more processors; and memory having instructions stored thereon, which when executed by the one or more processors cause the processors to perform operations, the operations including:
inputting an input word from a first region having an input word spelling, at least one input word definition and a first dialect;
selecting a second region wherein the second region comprises a second dialect;
assigning a High SpeVal to the input word;
matching the High SpeVal to at least one Low SpeVal;
identifying at least one second dialect word having a second dialect word definition and a second dialect word spelling in dependence of the at least one Low SpeVal;
comparing the input word definition for equality to the second dialect word definition the at least one second dialect word;
comparing the second dialect word spelling of the at least one second dialect word for equality to the input word spelling; and
outputting any of:
at least one identical word in the second dialect when the input word definition and the input word definition are equal to the second dialect word definition and the second dialect word spelling is equal to the second dialect word spelling of the at least one second dialect word; and
at least one similar word in the second dialect when the input word definition and the input word definition are equal to the second dialect word definition and the second dialect word spelling is not equal to the second dialect word spelling of the at least one second dialect word; and
at least one conflicting word when the input word definition and the input word definition are not equal to the second dialect word definition and the second dialect word spelling is not equal to the second dialect word spelling of the at least one second dialect word.

14. The computer system of claim 13, further comprising:
identifying at least one context sentence associated with the High SpeVal in the first dialect;
outputting the at least one context sentence;
matching a specific context sentence from the at least one context sentence in dependence of a predetermined meaning; and
wherein matching of the High SpeVal to the at least one Low SpeVal is in dependence of the specific context sentence and the High SpeVal.

15. The computer system of claim 14, further comprising:
identifying at least one similar context sentence associated with the at least one similar word in the second dialect;
comparing the specific context sentence with the at least one similar context sentence; and
outputting any of:
at least one alternative word from the at least one similar word when the specific context sentence is substantially similar to the at least one similar context sentence; and
at least one conflicting word from the at least one similar word when the specific context sentence is not substantially similar to the at least one similar context sentence.

16. A non-transitory computer-readable medium, having instructions stored thereon, which when executed by one or more processors cause the processors to perform operations, the operations including:
inputting an input word from a first region having an input word spelling, at least one input word definition and a first dialect;
selecting a second region wherein the second region comprises a second dialect;
assigning a High SpeVal to the input word;
matching the High SpeVal to at least one Low SpeVal;
identifying at least one second dialect word having a second dialect word definition and a second dialect word spelling in dependence of the at least one Low SpeVal;
comparing the input word definition for equality to the second dialect word definition the at least one second dialect word;
comparing the second dialect word spelling of the at least one second dialect word for equality to the input word spelling; and
outputting any of:
at least one identical word in the second dialect when the input word definition and the input word definition are equal to the second dialect word definition and the second dialect word spelling is equal to the second dialect word spelling of the at least one second dialect word; and
at least one similar word in the second dialect when the input word definition and the input word definition are equal to the second dialect word definition and the second dialect word spelling is not equal to the second dialect word spelling of the at least one second dialect word; and
at least one conflicting word when the input word definition and the input word definition are not equal to the second dialect word definition and the second dialect word spelling is not equal to the second dialect word spelling of the at least one second dialect word.

17. The non-transitory computer-readable medium of claim 16, further comprising:
identifying at least one context sentence associated with the High SpeVal in the first dialect;
outputting the at least one context sentence;
matching a specific context sentence from the at least one context sentence in dependence of a predetermined meaning; and
wherein matching of the High SpeVal to the at least one Low SpeVal is in dependence of the specific context sentence and the High SpeVal.

18. The non-transitory computer-readable medium of claim 17, further comprising:
identifying at least one similar context sentence associated with the at least one similar word in the second dialect;
comparing the specific context sentence with the at least one similar context sentence; and
outputting any of:
at least one alternative word from the at least one similar word when the specific context sentence is substantially similar to the at least one similar context sentence; and
at least one conflicting word from the at least one similar word when the specific context sentence is not substantially similar to the at least one similar context sentence.
